(19) United States
(12) Patent Application Publication
(10) Pub. No.: US 2009/0167030 A1
(43) Pub. Date: Jul. 2, 2009

(54) VERTICAL AXIS OMNI-DIRECTIONAL TURBINE

(76) Inventor: Philip G. Watkins, Torrance, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/398,973

(22) Filed: Mar. 5, 2009

Related U.S. Application Data
(63) Continuation of application No. 11/797,203, filed on May 1, 2007.

(51) Int. Cl. F03D 9/00; F03D 3/06; B23P 15/04

(52) U.S. Cl. 290/55; 416/235; 29/889

(57) ABSTRACT

A vertical axis turbine with a rotor driven by a group of vanes that assure starting at low speeds, efficiently generates electricity at all fluid flow speeds, especially under circumstances that include abrupt increase.

### RELATED APPLICATION

This application claims the benefit of and priority to co-pending and commonly assigned U.S. patent application Ser. No. 11/797,203, filed May 1, 2007, entitled “Vertical Axis Omni-Directional Wind Turbine”, the contents of which are incorporated by reference herein in its entirety.

### BACKGROUND

1. Field of the Invention

Vertical axis omni-directional axis turbines with enhanced efficiency of fluid stream energy and reliability of starting from rest.

2. Background of the Invention

Turbines are generally divided into two classes on the basis of the orientation of their axis of rotation. The preponderance of major turbine installations have their axis horizontal, facing into the wind, often with propeller type blades. These are frequently seen in large “farms” in canyon passes and on mountainsides.

Horizontal axis turbines require substantial trunnions and related mechanisms to face the turbine into the wind or water stream. A simple Aeromotor windmill is a classical example. It has a tail fin that exerts a torque to center the axis into the wind. These have decorated the farming landscape for decades, especially for pumping water from wells. As a source of modest amounts of energy for very localized usage, it has a well-deserved reputation, but it has fallen into comparative disuse as electrical power grids have been established, and as power requirements have increased beyond the capacity of such small devices. What is suitable for keeping a small water tank full or cattle is ordinarily not sufficient to power a modern house.

The relatively enormous modern turbine installations and their related generators, placed in locations where the wind or water flow is strong, have deservedly taken over most of the market. Smaller installations cannot enjoy the benefits of long blades and of transmissions and generators which require substantial housings.

Among the very practical limitations of the modern horizontal wind turbine is the height of the tower required for ground clearance of the large propellers. If the ground clearance is minimized, then so is the diameter of the blade system and the frontal area of the rotor system. These conditions are profound limits when one considers providing electrical energy for installations such as homes and small shops where ground clearances are of critical importance.

### SUMMARY

The fluid turbine of this invention includes a rotor having a central axis of rotation, and a mount that supports the rotor for rotation around a vertical axis through a bearing or family of bearings. A plurality of vanes are supported by the mount, individually by respective arms, or mounted to a rim that is supported by the arms.

The vanes are directed tangentially to the circular path on which they are supported, so that each vane makes a full rotation around its own centroid as it makes a full rotation around the central axis. In this sense the rotor is omni-directional. The reactive force of a fluid stream from one direction is the same as the force when the fluid stream impinges from any other direction.

In one embodiment, the vanes are all identical. Each has an axis, and is preferably mounted to the arm or to the rim tangentially. Each vane has a leading edge, a rounded nose at the leading edge, a dimension of height parallel to the axis of rotation, and a trailing edge. The term “tip speed” is used occasionally in this specification to describe the speed of the vane as a body. This speed is tangential to the path of the vanes.

The rounded nose extends to lips on each side of the vane, within which respective curved coves are formed, which blend into trailing faces that meet and terminate at the trailing edge of the vane.

An electrical generator is directly coupled to the rotor so as to be driven by it. The generator is preferably, although not necessarily, a permanent magnet type which is rigidly coupled to the rotor.

According to an embodiment of the present disclosure, the vane is so configured that when coupled to the generator, it will exhibit a substantially linear energy output that is limited by system parameters such as generator counter-EMF, bearing loads, and aerodynamic cleanliness of the vanes. The rotor will not run away. Importantly, when an abrupt acceleration by way of a substantial burst of fluid stream occurs near the terminal velocity at lower speeds, this turbine abruptly speeds up and persists at a higher rotary velocity while the higher fluid stream speed prevails.

### DRAWINGS

The above-mentioned features and objects of the present disclosure will become more apparent with reference to the following description taken in conjunction with the accompanying drawings wherein like reference numerals denote like elements and in which:

FIG. 1 is a top view of the presently preferred embodiment of a turbine according to this invention;

FIG. 2 is a side view of FIG. 1 taken at line 2-2 therein;

FIG. 3 is a top view of a vane in FIG. 1; and

FIG. 4 is a schematic view showing the relationships of the vanes to an incident fluid stream at various positions around the central axis.

### DETAILED DESCRIPTION

In the description that follows, the present disclosure will be described in reference to one or more preferred embodiments that utilize an omni-directional axis turbine for electric generation. The present disclosure, however, is not limited to any particular application nor is it limited by the examples described herein. The present disclosure, for example, may be used with any wind or water turbine electric generator. Therefore, the description of the embodiments that follow are for purposes of illustration and not limitation.

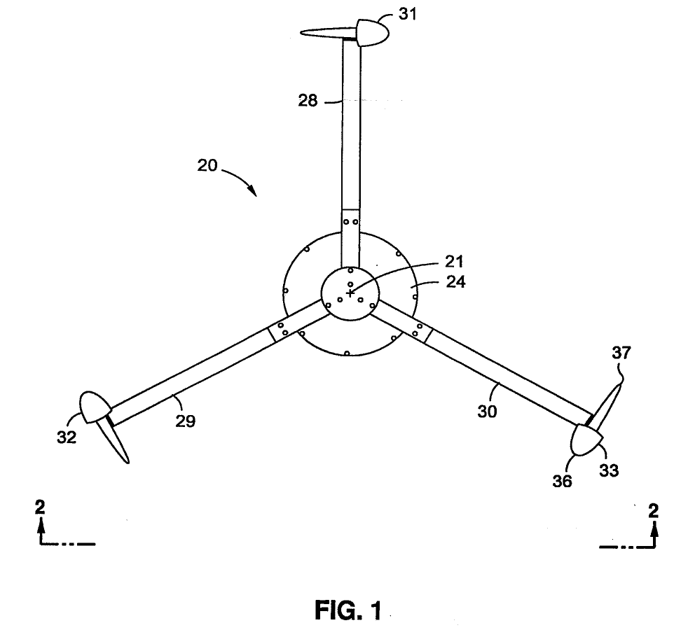

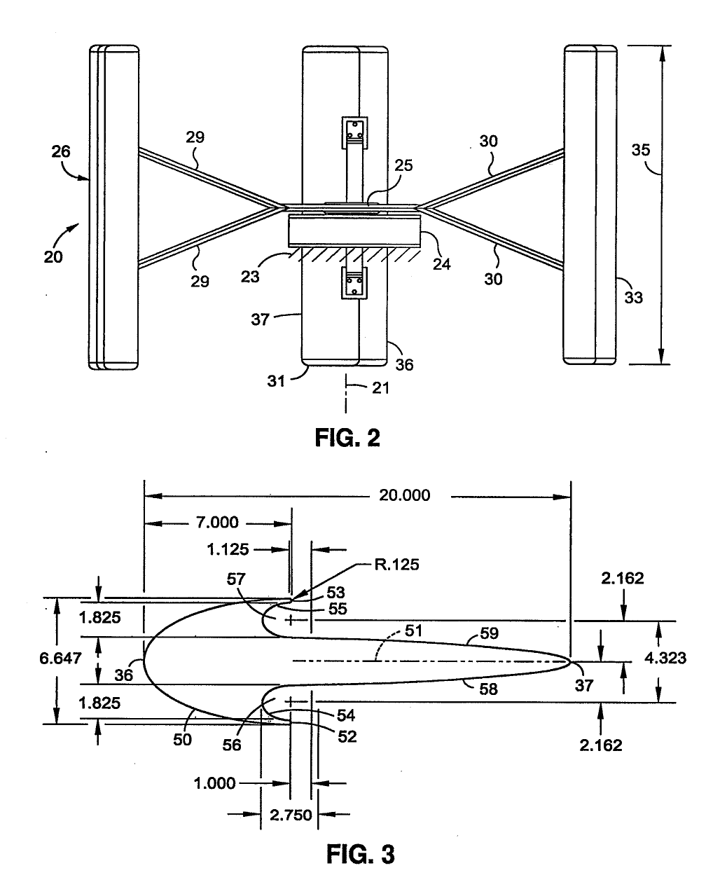

FIGS. 1 and 2 show a turbine 20 with a central axis of rotation 21 intended to stand vertically. As an example of its simplest and preferred structure, it is supported on a base 23 to which generator 24 is mounted. A bearing 25 supports rotor 26 and is directly connected to the rotor of the schematically-shown electrical generator so rotation of the rotor 26 drives the generator. Bearing 25 mounts two sets of three arms 28, 29, 30 each, one set above the other.

Vanes 31, 32, 33 are rigidly fixed to the ends of respective arms 28, 29, 30. While a rotor with only two vanes will function, it is subject to undesirable vibrations at some speeds. An odd number of vanes is to be preferred, and is illustrated. Use of odd numbers of vanes improves the starting reliability of the turbine at slower fluid flow.

The vanes are all identical. Each has a dimension 35 of height, a leading edge 36, and a trailing edge 37. In FIG. 1 the same vane is portrayed in three orientations. The rotor rotates around the central axis, traveling in the clockwise (positive) direction as shown in FIG. 1.

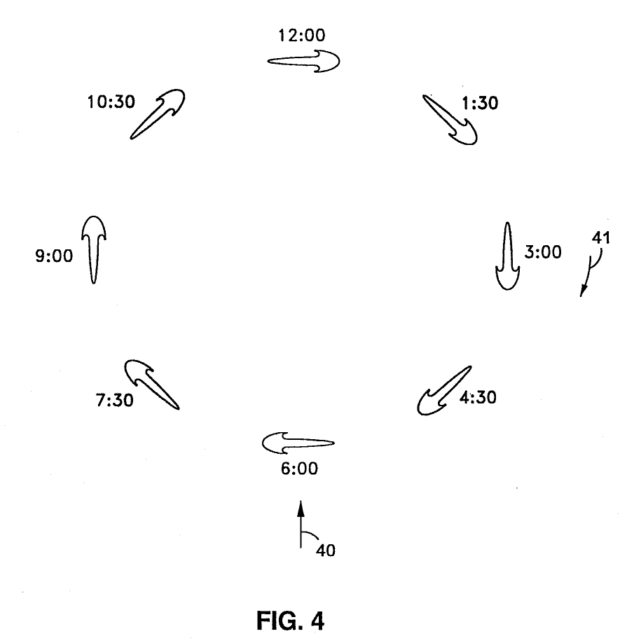

FIG. 4 is a schematic view disclosing the position of any of the vanes when in the illustrated locations. For convenience in explanation, the illustrative vane is shown in FIG. 4 at the following positions 12:00; 1:30; 3:00; 4:30; 6:00; 7:30; 9:00; and 10:30. Every vane goes through all of these positions (and all intervening positions) during each revolution, and itself makes a full revolution around its own centroid as it makes a complete turn around the central axis.

This is an omni-directional turbine. The same situation would exist when the fluid stream flows from any direction around the “clock”. For convenience, in FIG. 1 a fluid stream 40 is shown confronting the rotor at 6:00. This is an arbitrary selection of direction of the incident fluid stream. As it transpires, the rotation of the rotor viewed from above will be clockwise as shown by arrow 41. In this system, leading edge 36 progresses downwardly while going between 12:00 and 6:00, and upwardly between 6:00 and 12:00. Of course this means that between 12:00 and 6:00 the leading edge moves into the fluid stream, and between 6:00 and 12:00 it moves with it.

The vane reacts differently with the fluid stream at its various orientations around the path. It is the objective of this invention that the net sum of the reactive force of the fluid stream against the vane from all of the vane positions is a positive torque. It should be remembered that the vanes are not only driven by the fluid stream, but also are driven by the other vanes through the mount.

For this purpose the vane includes a number of specific shapes and dimension as best shown in FIG. 3. In that example, the height 35 is 10 feet, and the diameter of the rotor is 8 feet.

At its leading edge 36, the outer surface of the vane includes a bullet shaped nose 50 which is rounded in cross section across its own axis 51, The vane is symmetrical across the axis 51. The cross-section of the nose may be a circular or elliptical arc.

The nose extends rearwardly, to terminate at lips 52, 53. An inwardly concave surface 54, 55 at each side forms respective coves 56, 57. The cross-section curvature of the coves may be a circular arc.

Coves 56, 57 terminate at blade trailing faces 58, 59 which extend rearwardly to meet at trailing edge 37 of the vane. In the preferred embodiment shown, the blade is symmetrical across axis 57. The vane extends along an axis of height, dimension 35.

Faces 58, 59 are preferably shaped with a slight convexity as shown, rather than as a flat sheet, although a flat face will function reasonably well.

For convenience in discussion, lip 52 and cove 56 will be described as the “outer” lip and cove, and lip 53 and cove 57 as the “inner” lip and cove, because this will be their orientation when mounted to the rotor with the axis 51 of the vane tangential to the path of the vane around the central axis 21.

Suitable dimensions for the vanes used on the illustrated turbine shown are given on FIG. 3. Generally these may be scaled up or down, depending on the radial distance of the vane from the central axis of rotation on the size of the turbine, and on the number of vanes.

Discussion of the reactions of the vane will start at its six o'clock position and follow through the entire rotation, assuming that the fluid flow is from the 6:00 toward axis 21. The direction of rotation will be clockwise, viewed from above, as shown by arrow 41. Because this is an omni-directional device, the discussion would be the same for fluid flow coming from any other direction, relating to the direction from which it came.

In this example, in which it is assumed (FIG. 1) that there are three vanes 28, 29, 30, 120 degrees apart. With the turbine stopped, a vane at 6:00 will exert little if any torque. The turbine would be started by a vane between 6:00 and 12:00, because both of its coves “catch” the stream, along with some assistance from its blade. This guarantees that the turbine will start. As a vane progresses from 6:00 to 12:00, force from fluid flow will be exerted on its outer face and cove, and some in the inner cove also. The least favorable position for starting, is when one of the vanes is at 6:00.

As a vane 28 passes toward 8:00 (see FIG. 4), it moves to expose inner cove 56 to the stream. At 9:00, both coves are fully involved, the rounded nose creating little resistance to movement of the vane through the fluid stream which drives it.

After 9:00, the blade gradually moves to blind the outer cove, but exposes its blade surface to the stream as it also deflects the stream into the inner cove. This positive torque persists until the 12:00 position is reached. There still is, however, some torque exerted by fluid flow trapped in the inner cove.

The movement of the vane from 12:00 to 6:00 is less productive of positive torque than movement from 6:00 to 12:00, but from 12:00 to about 3:30 there is some. It is only between about 3:30 and 6:00 (vane 30 in FIG. 1) that at slow speeds there is only negligible clockwise torque from it, and perhaps some minor negative torque. However, it should be kept in mind that the vane at that time is being driven into the fluid stream by the other vanes.

Resistance of the vane to the fluid stream as the vane moves from 12:00 is minimized by the curvature of the nose. There appears to be some turbulence developed in the coves at this time, which prevents the generation of negative pressure in them which would otherwise exert a restraining force and also generates a positive pressure in the coves. The result is a torque exerted on the vane at this time which before about 3:00 can contribute some driving force.

Between about 3:30 and 6:00 at low speeds the vane contributes little force to drive the rotor, and sometimes none. Instead it is driven into the fluid stream by the rotor structure with force derived from the other vanes, and by momentum of the system.

From the foregoing it will be observed that there is always a substantial net driving force derived from each full rotation of a vane, and that the turbine will always start. The above describes the basic action of this turbine.

Starting at very low fluid flow is assured by using an odd number of vanes, although with only two vanes starting is also reliable, but requires a somewhat higher fluid flow. However, use of an even number of vanes often creates undesirable vibrations, which will not be generated when odd numbers of vanes are used. Therefore odd numbers of vanes are to be preferred.

In turbines of this type, the confronting net area of vanes as viewed in elevation as in FIG. 2 is of interest. Best operation is obtained when the fluid stream directly strikes the vanes. Of course the fluid flow is disrupted by other vanes when they cross the fluid stream ahead of it creating turbulence, and also extracting energy ahead of the downstream vane.

This consideration is called “solidity”. As the net confronting area increases, the efficiency of the turbine decreases. Accordingly there should be a balance, and the best results are obtained with a very efficient vane such as the instant vane, with fewest number of vanes placed on larger diameter rotors. The vanes of this invention are uniquely effective, can readily be used with as few as three in number, with rotors of sizes that are attractive to home and business installations. The reduced solidity is evident.

One useful turbine system according to the present disclosure, places the vanes of FIG. 3 about 4 feet from the central axis. It employs a permanent magnet generator. This turbine starts with a fluid stream as slow as about one mph. In one embodiment, the turbine system may be used to generate power at rates relative to wind speed as follows:

| WIND SPEED (mph) | SURGE OUTPUT (kW) | |
|---|---|---|
| 10 | 441.0 | W |
| 20 | 2.5 | kW |
| 30 | 9.55 | kW |

This turbine is well-suited to be directly connected to an in-line electrical generator, and needs no rigid mechanical transmission or directional orientation. As can be appreciated, different types of generators may used instead. However, the permanent magnet type is especially suited to rural and isolated installation.

A turbine with vanes according to this invention exhibits a surprisingly improved productivity at higher fluid flow following an abrupt but common circumstance to be described. Generally speaking, the power output of a turbine is substantially linear up to its terminal rotational velocity, especially in the range of slower fluid flow, up to for example about 12 mph for wind speed. The terminal velocity in some normal ranges of fluid flow is determined by a number of factors, prominently including bearing friction, aerodynamic consistency and cleanliness of the vanes, fluid density, the effects of counter-electromotive force (EMF) produced by the driven generator at higher rpms, and the negative force exerted on the leading edge of the vane by the fluid stream while it progresses from about 2:00 to 6:00.

Beyond this wind speed, the rotor does not greatly increase its rotational velocity with increased wind speed. It will not “run away”. However, there exists with this invention a surprising increase at higher wind speeds under certain circumstances.

Among the limitations of this rotor at slower speeds is the resistance or lack of contribution to the output of the vanes when they are between about 3:00 and about 6:00. The wind force confronting the vane at these positions exerts a limiting effect, and the tip speed of all vanes is therefore limited.

However, with this rotor and vanes if there is a sufficient surge in the fluid flow, the force applied to the vanes in the other positions will exert a rapid accelerative force on all of the vanes, including the vane when between 3:00 and 6:00, abruptly increasing the tip speed (by driving the system) so that the vane in this “unproductive” arc exerts an aerodynamic or hydrodynamic lift that instantly contributes to the driving of the rotor, and overcomes the previous terminal velocity limitations.

Interestingly, previously described impediments, reject the fluid resistance of the vanes when between 2:00 to 6:00, will limit the terminal velocity even at higher fluid flow. This limitation occurs, for example, in wind streams flowing up to about 17 mph. At this rotational velocity if there is a sudden gust, a sudden acceleration can occur. Then a tip speed acceleration of about 60 feet per second can be added to the existing approximately 17 mph velocity. This quickly accelerates the vane so that its tip speed ratio becomes between about 3.5-5.0:1. This overcomes the inefficiency of the vanes as they confront the wind stream, and the forces exerted by the vanes between about 6:00 to about 1:00 are able to drive the confronting vanes between 1:00 and 6:00, and the vanes between about 3:00 to about 6:00 not only no longer are an impediment, but instead create a driving torque with their lift. The result is an almost instant increase in rotational velocity, potentially up to a new set of limits.

Surprisingly, this result will not result from a gradual increase in fluid flow, but instead from gusts or other sudden surges in fluid flow. The higher speeds will continue so long as the faster fluid flow continues. If they decrease to below the previous rotor limit, the previous terminal limits will again be asserted.

This turbine is simple in construction, and elegant in its performance. It is an affordable source of electricity, especially for systems of moderate demand.

While the improved methods and systems for providing increased electric generation output has been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. In a vertical axis turbine of the type having a vertical axis of rotation, a mount, a bearing on said mount and a rotor fixed to said bearing for rotation around the said vertical axis, a plurality of axially extending vanes fixed to said mount at a radial distance from said central axis, and spaced arcuately from one another, whereby fluid flow impinging on the turbine from any direction will tend to drive the rotor, and an electrical generator fixed relative to the mount and functionally linked by the rotor to generate electricity, the improvement comprising:
each of said vanes having a dimension of length parallel to said central axis, a vane axis, and a uniform cross-section normal to said central axis and vane axis, said cross-section being characterized by an obtuse rounded nose at its leading edge, leading on each side of the vane axis to a terminal lip, an arcuately curved cove surface extending from said lip to a rearwardly-extending blade surface, said blade surface extending to the trailing edge of the vane, said cove surfaces fairing into said blade surfaces to create a cove between each said lip, the cove extending forwardly of said lips, said blade surfaces extending rearwardly beyond said coves to provide surfaces for reaction with the fluid flow.

2. The vertical axis turbine of claim 1, wherein said cove surfaces are concave.

3. The vertical axis turbine of claim 2, wherein said cove surfaces are circularly arcuate in cross-section.

4. The vertical axis turbine of claim 1, wherein said blade surfaces are obtuse in cross-section.

5. The vertical axis turbine of claim 1, wherein said blade surfaces are planar.

6. The vertical axis turbine of claim 1, wherein the plurality of said vanes are all parallel to said axis of rotation, and said generator rigidly connected to said rotor to be directly driven by said rotor.

7. The vertical axis turbine of claim 6, wherein said generator is a permanent magnet type.

8. The vertical axis turbine of claim 6, wherein said vanes are odd in number, and are equally spaced from the axis of rotation and from their nearest adjacent vane.

9. The vertical axis turbine of claim 1, wherein said cove and lip are provided on only one side of the vane.

10. An omni-directional turbine electric generator, comprising:
a plurality of vanes axially extending a radial distance from a central axis of rotation and spaced arcuately from one another, the plurality of vanes being driven by a fluid flow, each vane having a dimension of length parallel to the central axis, a vane axis, and a uniform cross-section normal to the central axis and vane axis, the uniform cross-section being characterized by an obtuse rounded nose at its leading edge, leading on each side of the vane axis to a terminal lip, an arcuately curved cove surface extending from the terminal lip to a rearwardly-extending blade surface, the blade surface extending to a trailing edge of the vane, the arcuately curved cove surface fairing into the blade surface to create a cove between each terminal lip, the cove extending forwardly of the terminal lip, the blade surface extending rearwardly beyond the cove to provide a surface for reaction with the fluid flow on each side of the vane axis;
a rotor driven by the plurality of vanes; and
an electric generator driven by the rotor to generate electricity.

11. The omni-directional turbine electric generator of claim 10, wherein the cove surface is concave.

12. The omni-directional turbine electric generator of claim 10, wherein the cove surface is circularly arcuate in cross-section.

13. The omni-directional turbine electric generator of claim 10, wherein the blade surface is obtuse in cross-section.

14. The omni-directional turbine electric generator of claim 10, wherein the blade surface is planar.

15. The omni-directional turbine electric generator of claim 10, wherein the electric generator is a permanent magnet type.

16. The omni-directional turbine electric generator of claim 10, wherein the plurality of vanes are odd in number, and are equally spaced from the central axis of rotation and from their nearest adjacent vane.

17. The omni-directional turbine electric generator of claim 10, wherein the cove and the lip are formed on only one side of each vane.

18. A method for fabricating a turbine electric generator responsive to fluid flow, the method comprising:
forming a plurality of vanes axially extending a radial distance from a central axis of rotation and spaced arcuately from one another, the plurality of vanes being driven by a fluid flow, each vane having a dimension of length parallel to the central axis, a vane axis, and a uniform cross-section normal to the central axis and vane axis, the uniform cross-section being characterized by an obtuse rounded nose at its leading edge, leading on each side of the vane axis to a terminal lip, an arcuately curved cove surface extending from the terminal lip to a rearwardly-extending blade surface, the blade surface extending to a trailing edge of the vane, the arcuately curved cove surface fairing into the blade surface to create a cove between each terminal lip, the cove extending forwardly of the terminal lip, the blade surface extending rearwardly beyond the cove to provide a surface for reaction with the fluid flow on each side of the vane axis; and
rotatably coupling the plurality of vanes to a generator rotor to harness electrical energy from the plurality of vanes.

19. The method of claim 18, wherein the cove and the lip are formed on only one side of each vane.

20. The method of claim 18, wherein the plurality of vanes are odd in number, and are equally spaced from the central axis of rotation and from their nearest adjacent vane.
